(19) United States
(12) Patent Application Publication
(10) Pub. No.: US 2009/0012838 A1
(43) Pub. Date: Jan. 8, 2009

(54) DETERMINATION OF A PREFERRED RATIO OF SUPERVISORS TO AGENTS IN CALL CENTERS

(75) Inventors: Kari DeJong, St. Paul, MN (US); Steve Sion, McMurray, PA (US); Stephanie Helland, Mound, MN (US); Eva Buren, New York, NY (US)

Correspondence Address: Vedder Price PC, 222 NORTH LASALLE STREET, CHICAGO, IL, 60601, US

(73) Assignee: Accenture Global Services GmbH, Schaffhausen (CH)

(21) Appl. No.: 11/772,859

(22) Filed: Jul. 3, 2007

(51) Int. Cl. G06F 17/00

(52) U.S. Cl. 705/10

(57) ABSTRACT

When determining a preferred ratio of supervisors to agents in a call center, one or more operation parameter values are determined for corresponding operation parameters. Based on the one or more operation parameter values, a benchmark ratio is correspondingly modified to provide the desired preferred ratio. Preferably, the benchmark ratio is identified based on a specific industry. At least one survey response concerning an operation parameter may be obtained and used in determining a corresponding operation parameter value. In this manner, a more structured and customized approach is provided in comparison to prior art techniques.

### FIELD OF THE INVENTION

The present invention relates generally to call centers and, in particular, to the determination of a preferred ratio of supervisors to agents in such call centers.

### BACKGROUND OF THE INVENTION

As generally known in the business world, a key differentiator between business competitors is often the level of service provided by such competitors to their current and potential customers. In order to improve the customer experience generally, such businesses have begun to use specialized services to handle inquires received from their current and potential customers. These specialized services and their physical implementations are typically referred to as call centers or contact centers.

Within a typical call center, a number of agents are provided to handle the various customer inquiries received typically by phone, electronic mail, instant messaging or any other similarly useful communication channel. As with any other business, there are additionally a number of supervisors provided to oversee the work and operations of the agents within the call center. In order to optimize performance of the call center, it is important to have the proper ratio of supervisors to agents (or, expressed alternatively, the proper ratio of agents to supervisors). If the ratio of supervisors to agents is too high, resources are needlessly expended in the form of extra supervisors. Conversely, if the ratio of supervisors to agents is too low, agents may not receive the proper guidance necessary and, as a result, the customer experience with such call centers may deteriorate. Thus, it is critical to provide the proper ratio of supervisors to agents. However, determination of an “ideal” supervisor to agent ratio may be affected by a variety of factors. For example, such factors may include the particular industry being served by the call center, the types of calls serviced by the call center and the amount of attrition within the agent ranks.

Currently, there is no structured method to determine an optimum supervisor to agent ratio for a call center environment. More typically, efforts to develop a proper supervisor to agent ratio are centered on personal experience, current staffing ratios and historic performance of a given call center. However, these approaches tend to be a little more than educated guesses to the extent that current and past performance may not necessarily reflect the future needs of the call center or the capabilities of the current agent population. It is not uncommon that call centers using this approach typically expand the ratio of agents to supervisor in order to be more cost effective, without understanding the negative effects of this approach, which often include increased attrition and reduced call quality.

Alternatively, there are published industry benchmarks that may be used to inform the determination of an appropriate supervisor to agent ratio. While these benchmarks may be useful starting points, they typically fail to take into consideration the specific realities of a given call center, the various roles to be played by the employees at the call center as well as the expectations of management. Therefore, a need exists for a technique for determining call center supervisor to agent ratios in a structured and fact-based manner that takes into account the particular circumstances of a given call center, thereby allowing customized solutions to be developed.

### SUMMARY OF THE INVENTION

The present disclosure describes various embodiments for determining a preferred ratio of supervisors to agents in a call center. In one embodiment, one or more operation parameter values are determined for corresponding operation parameters. Based on the one or more operation parameter values, a benchmark ratio is correspondingly modified to provide the desired preferred ratio. In order to select the benchmark ratio, a selected industry may first be identified applicable to the call center under consideration. Thereafter, the benchmark ratio may be identified based on the selected industry. Further still, when determining an operation parameter value, at least one survey response may be obtained concerning the operation parameter such that the operation parameter values are based on the one or more survey responses. In a presently preferred embodiment, the operation parameters include, but are not limited to, a strategy parameter, a process complexity parameter, a technology complexity parameter and a people parameter. Regardless of the particular operation parameters used, when the present techniques are implemented on a suitable processing platform, such as a computer, the resulting preferred ratio may be provided in a human perceptible format. In this manner, the limitations of prior art techniques for determining preferred ratios of supervisors to agents in call centers may be substantially overcome.

### BRIEF DESCRIPTION OF THE DRAWINGS

The features of the present invention are set forth with particularity in the appended claims. The present invention itself, together with further features and attendant advantages, will become apparent from consideration of the following detailed description, taking in conjunction with accompanying drawings. One or more embodiments of the present invention are now described, by way of example only, with reference to the accompanying drawings wherein like reference numerals represent like elements and in which:

FIG. 1 is a block diagram of an exemplary device that may be used to implement processing in accordance with the various embodiments of the present invention;

FIG. 2 is a flow chart illustration processing in accordance with an embodiment of the present invention;

FIG. 3 is a block diagram of an implementation of an apparatus for performing the processing set forth in accordance with the various embodiments of the present invention; and

FIG. 4 is an illustration of an exemplary user interface in accordance with an embodiment of the present invention.

### DETAILED DESCRIPTION OF THE PRESENT EMBODIMENTS

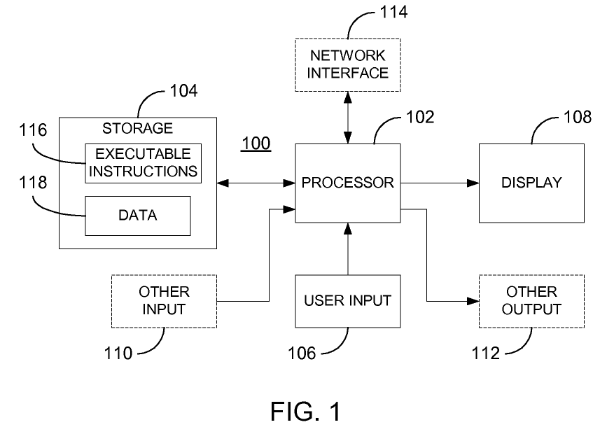

Referring now to FIG. 1, an exemplary device 100 that may be used to implement the present invention is further illustrated. In particular, the device 100 comprises a processor 102 coupled to a storage component 104. The storage component 104, in turn, comprises stored, executable instructions 116 and data 118. In a preferred embodiment, the processor 102 may comprise one or more processing devices such as a microprocessor, microcontroller, digital signal processor or combinations thereof capable of executing the stored instructions 116 and operating upon the stored data 118. Likewise, the storage component 104 may comprise one or more storage devices such as volatile or non-volatile memory including but not limited to random access memory (RAM), read-only memory (ROM), electrically-erasable programmable read-only memory (EEPROM), etc. Processor and storage arrangements of the type illustrated in FIG. 1 are well known to those having ordinary skill in the art, and various other suitable arrangements may be readily devised. In a presently preferred embodiment, processing in accordance with the various embodiments of the present invention is preferably implemented as a combination of executable instructions 116 and data 118 stored within the storage component 104.

In a presently preferred embodiment, the device 100 comprises one or more user input devices 106, a display 108, other input devices 110, other output devices 112 and a network interface 114, all in communication with the processor 102. The user input device 106 may comprise any mechanism for providing user input to the processor 102. For example, the user input device 106 may comprise a keyboard, a mouse, a touch screen, stylus or any other means known to those having ordinary skill in the art whereby a user of the device 100 may provide input data to the processor 102. The display 108 may comprise any conventional display mechanism such as a cathode ray tube (CRT), flat panel display, or any other display mechanism known to those having ordinary skill in the art. Techniques for providing display data from the processor 102 to the display 108 are well known in the art.

The other (optional, as illustrated by the dashed lines) input devices 110 may include various media drives (such as magnetic disc or optical disc drives), a microphone or any other source of input data or selection indications. Likewise, the other output devices 112 may optionally comprise similar media drive mechanisms as well as other devices capable of providing information to a user of the device 100, such as speakers, LEDs, tactile outputs, etc. Finally, the network interface 114 may comprise hardware and/or software that allows the processor 102 to communicate with other devices via wired or wireless network, as known in the art. Using the network interface 114, the techniques of the present invention may be performed in a remote manner, for example, as in the case of a Web application service.

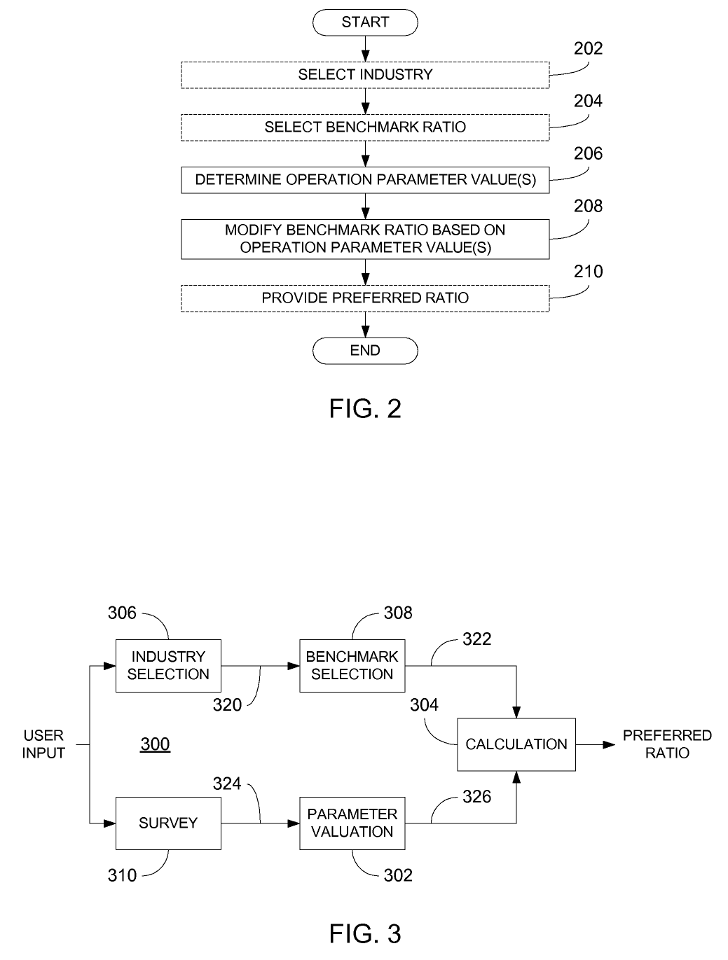

Referring now to FIG. 2, a flow chart further illustrating processing in accordance with the present invention is illustrated. Using techniques known in the art, the processing illustrated in FIG. 2 is preferably implemented using stored, executable instructions carried out by one or more suitable processors as illustrated, for example, in FIG. 1. Of course, those having ordinary skill in the art will appreciate that other techniques may be used to implement the processing illustrated in FIG. 2, including but not limited to, application specific integrated circuits (ASICs) programmable logic arrays, state machines, etc.

At the core of the processing illustrated in FIG. 2, blocks 206 and 208 are provided. At block 206, one or more operation parameter values corresponding to one or more operation parameters are determined. Generally, an operation parameter describes certain features or characteristics relevant to operation of call centers and that, when assessed, may provide useful data for modifying a benchmark ratio in order to more accurately reflect the condition of a given call center. In a presently preferred embodiment, the at least one operation parameter comprises any one or more of a strategy parameter, a process complexity parameter, a technology complexity parameter and a people parameter. Generally, the strategy parameter concerns the adopted or desired strategy for operating the call center in terms of the level of service to be provided by the call center. The process complexity parameter concerns the complexity and number of various tasks undertaken by agents in the call center. The technology complexity parameter assesses the level of technology used by agents in completing their tasks as well as the level of technology used in implementing the call center operations generally. Finally, the people parameter assesses the average capabilities of the agents being supervised as well as the specific tasks and/or metrics for which supervisors are responsible. Those having ordinary skill in the art will appreciate that various other parameters may be selected and designated for this purpose.

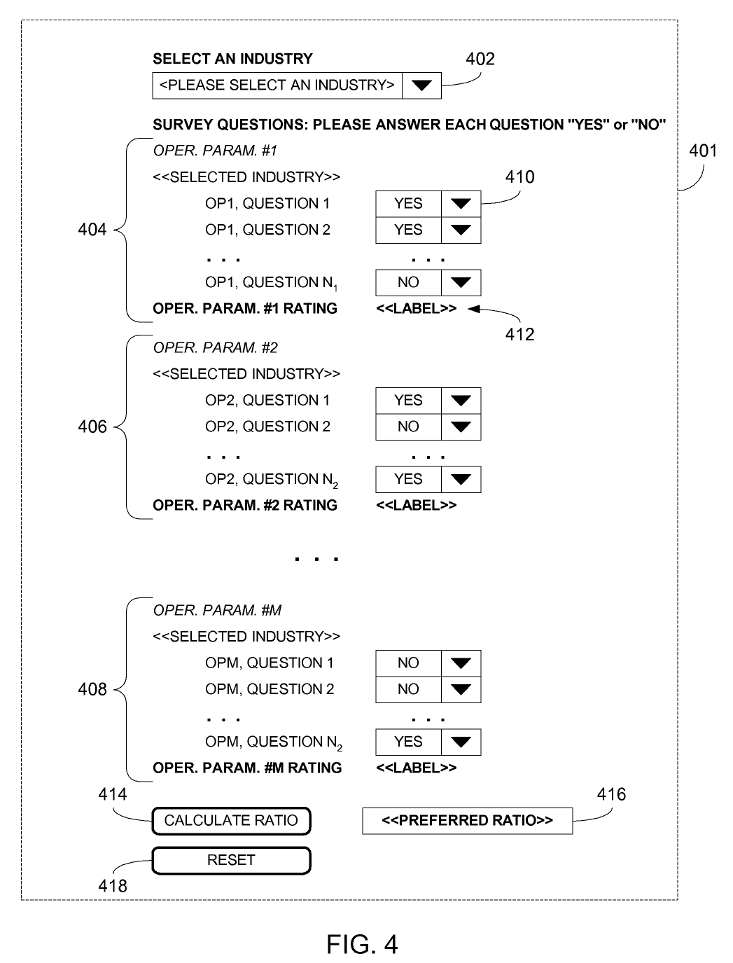

Likewise, various techniques may be employed for determining the one or more operation parameter values corresponding to the designating operation parameters. A presently preferred technique for determining operation parameter values, further illustrated below with reference to FIGS. 3 and 4, is to assess the answers to a number of questions dedicated to each operation parameter to determine a rating (operation parameter value) for each operation parameter. Table 1 below illustrates various exemplary questions that may be used to assess the four operation parameters described above. Note that the exemplary questions illustrated below are designed to be answered on a yes/no basis, as described in further detail below. However, those having ordinary skill in the art will appreciate that questions designed to assess parameter values may be phrased differently so as to, for example, provide a broader range of possible responses. The present invention is not limited in this regard. For example, the responses to the questions may be restricted to an expression of percentage of time spent on specific tasks such that the sum of all responses equals 100%. As described below, the resulting total percentage may serve as the basis for assigning a particular rating and value for the corresponding operation parameter. Alternatively, the total percentage itself (e.g., 85% or 0.85) may be directly used as the parameter value. Furthermore, the questions set forth below are particularly directed to a call center focused on providing service support. However, the techniques described herein are equally applicable to other types of call centers, e.g., those providing sales support, technical support, etc. In these instances, the questions employed to assess the various parameters may be selected according to the type of call center under consideration. Further still, the particular questions presented need not be static and may be, for example, context-dependent based on answers provided to other questions. For example, answering “yes” to a given question may cause one set of other questions to be presented, whereas answering “no” to that same question may cause yet another set of questions to be presented. Techniques for presenting questions in this manner are known in the art.

TABLE 1
Strategy Parameter
Requires high agent touch points for most of the transaction types.
Has implemented a customer-centric strategy.
Has home-based agents.
Holds supervisors responsible for more than five key metrics.
Has metric goals that are considered high for this industry.
Process Complexity Parameter
Receive mostly complex call types.
Are responsible for upselling.
Are responsible for troubleshooting.
Are responsible for logging cases on every call.
Are responsible for both inbound and outbound call types.
Use a knowledge base tool while on the phone with the customer.
Escalate more than 5% of their calls to their supervisors.
Technology Complexity Parameter
Uses more than five applications while on the phone with the customer.
Reverts to manual processes at least once a day due to technical issues.
Has self-servicing (IVR, web, etc.) options for customers.
People Parameter
Agents average less than two years of customer service experience.
Averages greater than 5% of current staff in new hires each month.
Has floor support assistance (i.e. Team Leads, Seniors, etc.)
Introduces a high level of change to the environment on a monthly basis.
Supervisors are responsible for:
Attending Meetings
Coaching
Developing Process Improvements
Handling Call Escalations
Interacting with Clients (different than escalations)
Interacting with Internal Departments
Managing Queues
Monitoring Calls
Processing Paperwork
Recruiting
Scheduling
Scoring Calls (Quality Assurance)
Training
Other

The responses to the various questions corresponding to an operation parameter may be tabulated, combined or otherwise operated upon to provide the operation parameter value for that operation parameter. For example, with reference to the groups of questions illustrated in Table 1, various ratings for each operation parameter may be established according to the following exemplary rules: if the number of “yes” responses is less than ⅓ the total number of questions, assign a “high” rating; if the number of “yes” responses is greater than ⅓ the total number of questions and less than ⅔ the total number of questions, assign a “normal” rating; and if the number of “yes” responses is greater than ⅔ the total number of questions, assign a “low” rating. In this example, the response to each question is equally weighted. However, this is not a requirement and it is possible to weight the responses to individual questions differently, e.g., such that a particular response to a particularly heavily weighted question results in a change in rating. Regardless, and continuing with the previous example, the numerical operation parameter values are assigned according to the corresponding ratings. For example, a “high” rating results in an operation parameter value of 2, a “normal” rating results in an operation parameter value of 1, and a “low” rating results in an operation parameter value of 0.5. Labels may also be provided as a description of how the ratings (determined according to the answers to the various questions for each parameter) translate into a “real-world” assessment of that parameter. Various examples of such ratings, values and labels for the parameters of Table 1 are set forth below in Table 2 below. Of course, it is understood that a greater or lesser number of ratings other than “high”, “normal” and “low” may be employed as a matter of design choice, and that all parameters do not need to adhere to the same taxonomy of ratings. Similarly, the exemplary values and labels illustrated in Table 2 are not exhaustive of the various possibilities, as will be apparent to those of skill in the art.

TABLE 2
Strategy Parameter

| | |
|---|---|
| “High” rating: numeric value = 2; | label → “low touch” |
| “Normal” rating: numeric value = 1; | label → “medium touch” |
| “Low” rating: numeric value = 0.5; | label → “high touch” |

Process Complexity Parameter

| | |
|---|---|
| “High” rating: numeric value = 2; | label → “simple” |
| “Normal” rating: numeric value = 1; | label → “challenging” |
| “Low” rating: numeric value = 0.5; | label → “complex” |

Technology Complexity Parameter

| | |
|---|---|
| “High” rating: numeric value = 2; | label → “intelligent integration” |
| “Normal” rating: numeric value = 1; | label → “normal” |
| “Low” rating: numeric value = 0.5; | label → “complex environment” |

People Parameter

| | |
|---|---|
| “High” rating: numeric value = 2; | label → “focused” |
| “Normal” rating: numeric value = 1; | label → “normal” |
| “Low” rating: numeric value = 0.5; | label → “complex” |

Regardless of the manner in which the operation parameter values are determined, processing continues at block 208 where a benchmark ratio is modified based on the one or more operation parameter values determined at block 206 to provide the preferred ratio. In this manner, the benchmark ratio may be modified to more accurately reflect the realities of a given call center as determined by its operation parameter values. For example, in one embodiment of the present invention, where the operation parameter values are represented as numeric values, the benchmark ratio may be directly scaled by each operation parameter value. For example, the numeric values could range from 0.5 to 2, where values for a parameter value below 1 cause a reduction in the ratio (i.e., a relative decrease in the number of supervisors) and where values above 1 cause an increase in the ratio (i.e., a relative increase in the number of supervisors). Alternatively, the benchmark value could be scaled by an average of the operation parameter values. Weighting can also be employed such that individual operation parameter values are weighted differently relative to one another in the calculation. Using known techniques, the operation parameter values can be de-correlated relative to each other to avoid any duplicative scaling effects resulting from the nature of the questions used to assess the operation parameter values. Further still, other, more objective, operation parameter values may be employed. For example, the type of call center (e.g., service, sales, technical support, etc) and/or location of the call center (e.g., United States, India, Philippines, etc.) may be employed. In these instances, it may not be necessary to assess the operation parameter based on a multi-question survey. Thus, location of a call center in India may lead to one operation parameter value, whereas location in the Philippines leads to another operation parameter value, given the common understanding that these different locations (independent of the other operation parameters) typically require different supervisor to agent ratios. Similar logic may be applied to the types of call centers where it is again understood that, for example, that a sales call center generally requires a different supervisor to agent ratio than a technical support call center. As will be apparent to those of skill in the art, further algorithms for modifying the benchmark ratio based on the various operation parameter values may be readily employed as a matter of design choice.

As noted above, blocks 206 and 208 are the core of the processing illustrated in FIG. 2. However, various other blocks in accordance with further embodiments of the present invention, are also illustrated. Thus, at block 202, an industry is selected that is particularly applicable to the call center under consideration. Generally, virtually any mechanism may be used for selecting an industry, although a particular implementation is further illustrated with reference to FIGS. 3 and 4, described below. In a presently preferred embodiment, only those industries for which benchmark ratios are available are available for selection, although other implementations are possible. Examples of suitable industry categories and sub-categories are set forth in Table 3 below.

TABLE 3

| Industry Category | Industry Sub-Categories |
|---|---|
| Automotive | Automobile Dealers, Automotive Suppliers, On-Road Trucks, Original |
| | Equipment Manufacturers |
| Banking | Commercial/Corporate Banking, Private Banking/Wealth Management, |
| | Retail/Consumer Banking |
| Capital Markets | Asset/Investment Management, Custody |
| | Exchanges and Infrastructure, Investment Banking, Retail Brokerage |
| Chemicals | — |
| Communications | Cable, Wireless, Wireline |
| Industry | |
| Construction | — |
| Consumer Goods | Apparel and Footwear, Beverages Wine and Spirits, Food Manufacturing, |
| and Services | Food Service, Household Products and Personal Care, Tobacco, |
| | Wholesale |
| Electronics | Aerospace and Defense, Communications Equipment, Computers, |
| | Consumer Electronics, Data Storage Equipment, Industrial Electronics, |
| | Office Equipment, Semiconductors, Software |
| Energy | Downstream, Gas and Power, Upstream |
| Forest Products | — |
| Government | Agriculture, Customs, Defense, Education, Finance and Administration, |
| | Human Services, Immigration, Justice, Postal, Public Safety, Public |
| | Transit Authorities, Revenue and Taxation |
| Health and Life | Government Health, Payer, Pharmaceuticals and Medical Products, |
| Sciences | Provider |
| Industrial | Consumer Durables, Heavy Equipment, Industrial and Electrical |
| Equipment | Equipment |
| Insurance | Life Insurance, Property & Casualty |
| Media and | Broadcasting, Film, Gambling, Games, Music, Printing and Publishing, |
| Entertainment | Sports, Themed Entertainment |
| Metals | — |
| Mining | — |
| Retail | Apparel (Softlines), Convenience Stores, Department and Discount |
| | Stores, Do-It-Yourself (DIY), Drug Stores, Grocery, Hardlines, |
| | Internet/Catalog/Mail Order, Professional Services, Quick Service |
| | Restaurants |
| Transportation | Airlines, Freight, Public Transport, Travel Services |
| Utilities | Transmission and Distribution, Wholesale & Generation, Retail |

Regardless of the manner in which the industry (or whatever criteria being employed) is selected, processing can continue at block 204 where a benchmark ratio is selected based on the selected industry (and/or other criteria). Such benchmark ratios may be obtained through published data, such as that provided by Benchmark Portal, or may be developed through proprietary, in-house databases. In one embodiment of the present invention, the benchmark ratio for a given industry represents an average ratio of supervisors to agents for that industry.

Finally, regardless of the manner in which the benchmark ratio is determined and modified, processing may continue at block 210 where the resulting modified benchmark ratio is provided as the preferred ratio. For example, in a presently preferred embodiment, the preferred ratio is provided to a user in a human perceptible format such as on a video display screen or printer, audibly, etc. Alternatively, providing the preferred ratio may include sending the preferred ratio to an entity via a communication network, such as the Internet or World Wide Web. The present invention is not limited in this regard.

Referring now to FIG. 3, an apparatus for determining a preferred ratio of supervisors to agents in a call center in accordance with an embodiment of the present invention is further illustrated. In a presently preferred embodiment, the apparatus 300 is implemented using, for example, the processing device 100 illustrated in FIG. 1. In this embodiment, each of the various components illustrated in FIG. 3 may comprise one or more software modules, data structures, etc. as known in the art. Once again, however, other hardware-based techniques, or combinations of hardware and software techniques may be equally employed.

As shown, the apparatus illustrated converts user input into a preferred ratio. In one embodiment, a parameter valuation component 302 provides operation parameter values 326 based upon survey responses 324, e.g., answers to yes/no questions. The resulting operation parameter values 326 are provided to a calculation component 304 that may use virtually any algorithm (various examples of which are described above) to calculate the preferred ratio based on the benchmark ratio 322.

As further described above, it is preferable to base the benchmark ratio 322 on a specific industry (or some other criteria). To this end, an industry selection component 306 is provided to take user input and, in response thereto, provide a selected industry 320. For example, in a presently preferred embodiment, the industry selection component 306 operates as a drop-down menu 402 (FIG. 4) in which the various menu entries are the available industry categories, several examples of which are set forth above. Once again, other selection mechanisms may be equally employed for this purpose as a matter of design choice. Regardless, the selected industry 320 is provided to the benchmark selection component 308 where the benchmark ratio 322 is provided in response to the selected industry 320. For example, in a presently preferred embodiment, the benchmark selection component 308 may be implemented as a look-up table in which the selected industry 320 is used to index the appropriate ratio value 322 in the table. Where different types of benchmark ratios are available (as differentiated, for example, by the source of the benchmark ratios), multiple such tables may be employed (and necessitating a selection mechanism for the desired benchmark type).

Finally, one or more user inputs may be also provided to a survey component 310 provided to gather and assess survey responses 324 (such as the responses to the exemplary yes/no questions described above) that are thereafter provided to the parameter valuation component 302. The survey component 310 provides a mechanism for obtaining information reflective of the actual operating circumstances of the call center under consideration. An example of an embodiment for implementing the survey component 310 is further illustrated with regard to FIG. 4.

Referring now to FIG. 4, an exemplary user interface 401 is further illustrated. In particular, the user interface 401 implements the functionality described above concerning the use of survey questions to develop operation parameter values. As shown, the exemplary interface 401 comprises an industry selection mechanism 402 (or other criteria selection mechanism, as noted previously) illustrated in this embodiment as a pull-down menu. However, various other control types (e.g., alphanumeric input boxes, etc.) as known to those having ordinary skill in the art may be equally employed for this purpose. Using the industry selection mechanism 402 a user of the interface 401 may select an industry of their choice. As also shown, various portions 404-408 of the interface 401 provide a variety of questions and corresponding response input mechanisms 410 that may be used to assess operation parameter values for the corresponding operation parameters. In the illustrated example, each of the different operation parameters (1-M) has a corresponding variety of questions (1-N₁, 1-N₂ . . . 1-NM). As shown, each of question is presented in a form requiring a yes/no response, which may be provided through suitable input mechanisms 410. Based on the responses to each question, a rating label 412 (as described above) may be displayed for each operating parameter. As also described above, an operation parameter value (not shown) is also determined based on input responses. By answering each of the corresponding questions, operation parameter values may be provided for each of the designated operations parameters and selection of a calculate ratio button 414 provides a preferred ratio 416 on the user interface 401. As known in the art, in order to facilitate reuse of the data provided, a reset button 418 may also be provided. In a presently preferred embodiment, the label 412 depicted on the user interface 401 comprises alphanumeric text, whereas the operating parameter value used for the calculation of the preferred ratio is not displayed. However, other embodiments are possible where only the numerical value is displayed, or both the label and value are displayed, as a matter of design choice.

As described above, the present invention provides a technique for determining a preferred supervisor to agent ratio for call center operations. This is achieved through the use of specifically-identified benchmark ratios that are subsequently modified in accordance with assessed operation parameter values unique to a given call center. In this manner, a more structured and customized approach is provided. For at least these reasons, the present invention represents an advancement over prior art techniques.

While the particular preferred embodiments of the present invention have been shown and described, it will be obvious to those skilled in the art that changes and modifications may be made without departing from the teachings of the invention. For example, ratios of agents to supervisors, as opposed to the inverse, may be equally employed without loss of generality. It is therefore contemplated that the present invention cover any and all modifications, variations or equivalents that fall within the scope of the basic underlying principles disclosed above and claimed herein.

What is claimed is:

1. A method for determining a preferred ratio of supervisors to agents in a call center, the method comprising:
determining at least one operation parameter value corresponding to at least one operation parameter of the call center; and
modifying a benchmark ratio based on the at least one operation parameter value to provide the preferred ratio.

2. The method of claim 1, further comprising:
determining a selected industry applicable to the call center, wherein the benchmark ratio is identified based on the selected industry.

3. The method of claim 1, wherein determining the at least one operation parameter value further comprises, for each of the at least one operation parameter:
obtaining at least one survey response concerning the operation parameter; and
determining an operation parameter value based on the at least one survey response.

4. The method of claim 1, wherein the at least one operation parameter comprises any one or more of: a strategy parameter, process complexity parameter, technology complexity parameter and a people parameter.

5. The method of claim 1, further comprising:
providing the preferred ratio in a human-perceptible format.

6. In a processing device comprising at least one user input component and at least one user output component, a method for determining a preferred ratio of supervisors to agents in a call center, the method comprising:
receiving, via the at least one user input device, user input indicative of a selected industry applicable to the call center;
identifying a benchmark ratio based on the selected industry;
receiving, via the at least one user input device, at least one survey response concerning at least one operation parameter of the call center;
modifying the benchmark ratio based at least in part upon the at least one survey response to provide the preferred ratio; and
outputting the preferred ratio via the at least one user output component.

7. The method of claim 6, wherein the at least one operation parameter comprises any one or more of: a strategy parameter, process complexity parameter, technology complexity parameter and a people parameter.

8. A medium capable of being read by a processing device and comprising executable instructions stored thereon that, when executed by the processing device, cause the processing device to:
determine at least one operation parameter value corresponding to at least one operation parameter of a call center; and
modify a benchmark ratio of supervisors to agents in the call center based on the at least one operation parameter value to provide a preferred ratio.

9. The medium of claim 8, further comprising executable instructions stored thereon that, when executed by the processing device, cause the processing device to:
determine a selected industry applicable to the call center; and
identify the benchmark ratio based on the selected industry.

10. The medium of claim 8, wherein the executable instructions that are operative to determine the at least one operation parameter value are further operative to, for each of the at least one operation parameter:
obtain at least one survey response concerning the operation parameter; and
determine an operation parameter value based on the at least one survey response.

11. The medium of claim 8, wherein the at least one operation parameter comprises any one or more of: a strategy parameter, process complexity parameter, technology complexity parameter and a people parameter.

12. The medium of claim 8, further comprising executable instructions that, when executed by the processing device, cause the processing device to:
provide the preferred ratio in a human-perceptible format.

13. An apparatus for determining a preferred ratio of supervisors to agents in a call center, comprising:
a parameter valuation component operative to determine at least one operation parameter value corresponding to at least one operation parameter of the call center; and
a calculation component, in communication with the parameter valuation component, operative to modify a benchmark ratio based on the at least one operation parameter value to provide the preferred ratio.

14. The apparatus of claim 13, further comprising:
an industry selection component operative to provide a selected industry applicable to the call center; and
a benchmark selection component, in communication with the calculation component, operative to provide the benchmark ratio in response to the selected industry.

15. The apparatus of claim 14, wherein the benchmark selection component is further operative to determine an average ratio corresponding the selected industry.

16. The apparatus of claim 14, further comprising:
a survey component, in communication with the parameter valuation component, operative to, for each of the at least one operation parameter, obtain at least one survey response concerning the operation parameter and determine an operation parameter value based on the at least one survey response.
